(19) United States
(12) Patent Application Publication
(10) Pub. No.: US 2013/0056265 A1
(43) Pub. Date: Mar. 7, 2013

(54) ELECTRIC CABLE (EMBODIMENTS)

(71) Applicant: Oleksandr Yul'Evich Khotenko, Kiev (UA)

(72) Inventor: Oleksandr Yul'Evich Khotenko, Kiev (UA)

(21) Appl. No.: 13/697,379

(22) PCT Filed: Apr. 19, 2011
(86) PCT No.: PCT/UA2011/000028

§ 371 Date: Nov. 12, 2012

(30) Foreign Application Priority Data
May 19, 2010 (UA) A 2010 06039

(51) Int. Cl. H01B 9/02

(52) U.S. Cl. 174/70 R; 174/102 R

(57) ABSTRACT

The invention relates to the field of electrical engineering and can be used to transmit audio, video and digital signals and to connect acoustic systems to distribution amplifiers. The electric cable contains two current-carrying wires; a signal wire and a neutral wire. The wires are separated from each other by dielectric layers and screens of conductive material which cover the entire length of a current-carrying wire. In another embodiment of the electric cable, each screen is connected to a current-carrying wire via a resistor. In yet another embodiment of the cable, the resistor is shunted by a capacitor. The invention makes it possible to enhance the quality of electric signal transmission by neutralizing capacitance between the wires and also suppresses parasitic electrical oscillating processes and expands the bandwidth of the cable.

The invention relates to the field of electrical engineering and can be used to transmit audio, video, and digital signals, and to connect acoustic systems to the distribution amplifiers, in radio engineering, electrical engineering and other fields.

It is known a screened two-wire cable wherein there are two current-carrying wires, namely, a signal wire and a neutral wire. The wires are placed in a common screen of a conductive material. Outside the cable, being the cable input side, the screen can be connected to the neutral current-carrying wire of the cable or to a signal source body. The electric field force lines are oriented between the signal wire and the neutral wire as well as between the signal wire and the screen. The external electric field is zero. Due to the availability of the electric field, which is distributed along the whole length of the cable, there is formed distributed capacitance between the signal wire and the neutral wire, and the capacitance between the signal wire and the screen.

It is also known a screened three-wire cable wherein there are three current-carrying wires, two of which are anti-phase signal wires and one wire is a neutral wire. The wires are arranged in a common screen of a conductive material. Outside the cable, being on the cable input side, the screen can be connected to the neutral current-carrying wire of the cable or to a signal source body. The electric field force lines are oriented between the signal wires, between the signal wires and the neutral wire as well as between the signal wires and the screen. The external electric field is zero. Due to the availability of the electric field, which is distributed along the whole length of the cable, there is formed distributed capacitance between the signal wire and the neutral wire, and the capacitance between the signal wire and the screen [Electric Cables, Wires, and Cords: Handbook/D. Bachelis, N. Belorussov, A. Saakian: Edited by N. Belorussov.—2nd Ed., Rev.—M. L. Gosenergo, 1963. Pages 58-118)].

In such cable designs, because of the availability of the distributed capacitances between the signal and neutral wires, and between the signal wire and the screen in the screened two-wire cable as well as between the signal wires, between the signal wires and the neutral wire, and between the signal wires and the screen in the screened three-wire cable, which get interacting with current and voltage of the signals along all the length of the cable, interact with the output circuits of the signal source, there are distorted the amplitude-frequency and phase-frequency characteristics of the signal, there is distorted the current and voltage waveforms of the signal reducing their amplitude. When changing the signal polarity, the process of the distributed linear capacitance charge exchange increases the dielectric losses of the signal energy in the dielectric, also while introducing a distortion into the signal it diminishes the propagation velocity of the signal and augments its group delay. Besides, at changing the direction of the dielectric polarization, the noise generated by the molecules of the dielectric dipole is added to the useful signal

The closest to the claimed invention is a screened standard coaxial cable containing two wires arranged coaxially with a dielectric layer between them. The internal wire made of a smaller diameter has a cross section in the form of a circle, and the external wire made of a larger diameter has a cross section in the form of a ring. The internal current-carrying wire is a signal wire, and the external wire is a neutral current-carrying wire [Electric Cables, Wires, and Cords: Handbook)/D. Bachelis, N. Belorussov, A. Saakian: Edited by N. Belorussov.—2nd Ed., Rev.—M. L. Gosenergo, 1963. Pages 58-118)].

At feeding an electric signal to the cable input, the electric field force lines inside the cable are oriented radially from the internal signal wire to the external neutral wire, along the entire length of the cable. The external electric field is equal to zero. Due to the availability of the electric field distributed along the entire length of the cable, there is organized the distributed capacitance between the signal wire and the neutral wire.

In this cable design, as in the previous analogies, because of the availability of the distributed capacitance between the signal wire and the neutral wire, which interacts with current and voltage of the signal along the entire length of the cable and interacts with the output circuits of the signal source, there are distorted the amplitude-frequency and phase-frequency characteristics of the signal, there is distorted the current and voltage waveforms of the signal reducing their amplitude. When changing the signal polarity, the process of the distributed linear capacitance charge exchange increases the dielectric losses of the signal energy in the dielectric, also while introducing a distortion into the signal, it diminishes the propagation velocity of the signal and augments its group delay. Besides, at changing the direction of the dielectric polarization, the noise generated by the molecules of the dielectric dipole is added to the useful signal All this reduces the quality of the electrical signals transmission.

The basis of the claimed invention is to provide a electrical cable, which would enhance the quality of electrical signal transmission by neutralizing distributed capacitance and suppress parasitic electrical oscillating processes.

The problem is solved as follows: in the electric cable comprising at least two current-carrying wires, namely, a signal wire and a neutral wire with dielectric layers between them, according to the invention, the current-carrying wires are separated from each other by at least three dielectric layers, and at least two screens of conductive material disposed between the dielectric layers alternating with them, and along the entire length of the cable, from its input to the output, each screen covers only one current-carrying wire connected to it on the input side.

The screens create obstacles in the path of the electric field lines between the current-carrying wires and neutralize the capacitance between them due to the fact that each screen-formed surface is a conductive one being under the same voltage as the current-carrying wire that is separated by the screen. The capacitance between the screens affects neither current nor voltage of the signal while propagating through the current-carrying wires, because the capacitance is focused only on the input of the cable, and its influence is directed only to the signal source.

As a consequence, the quality of the electrical signals transmission is improved.

Connecting the screen with the current-carrying wire via resistor contributes to suppressing the parasitic electrical oscillating processes that might arise under the condition of the signal source output circuits' interaction with the capacitance in the space between the screens. This fact also significantly improves the quality of the electrical signals transmission.

Shunting the resistor by the capacitor expands the cable bandwidth. In the absence of the capacitor, the bandwidth is limited by RC filter organized by the resistor and the capacitance occurred between the screens.

The invention is illustrated by the following diagrams.

FIG. 1 shows the first alternative embodiment of the coaxial cable with the screened signal and the screened neutral wires;

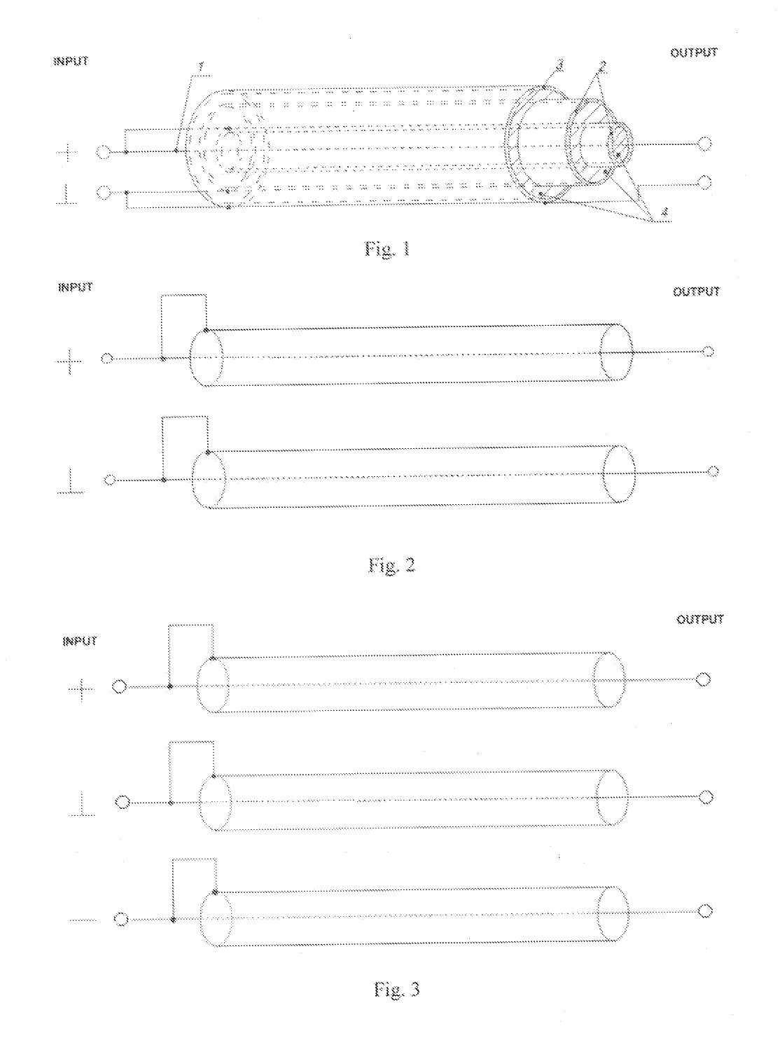

FIG. 2 shows the first alternative embodiment of the two-wire cable;

FIG. 3 shows the first alternative embodiment of the balanced cable with three screened wires;

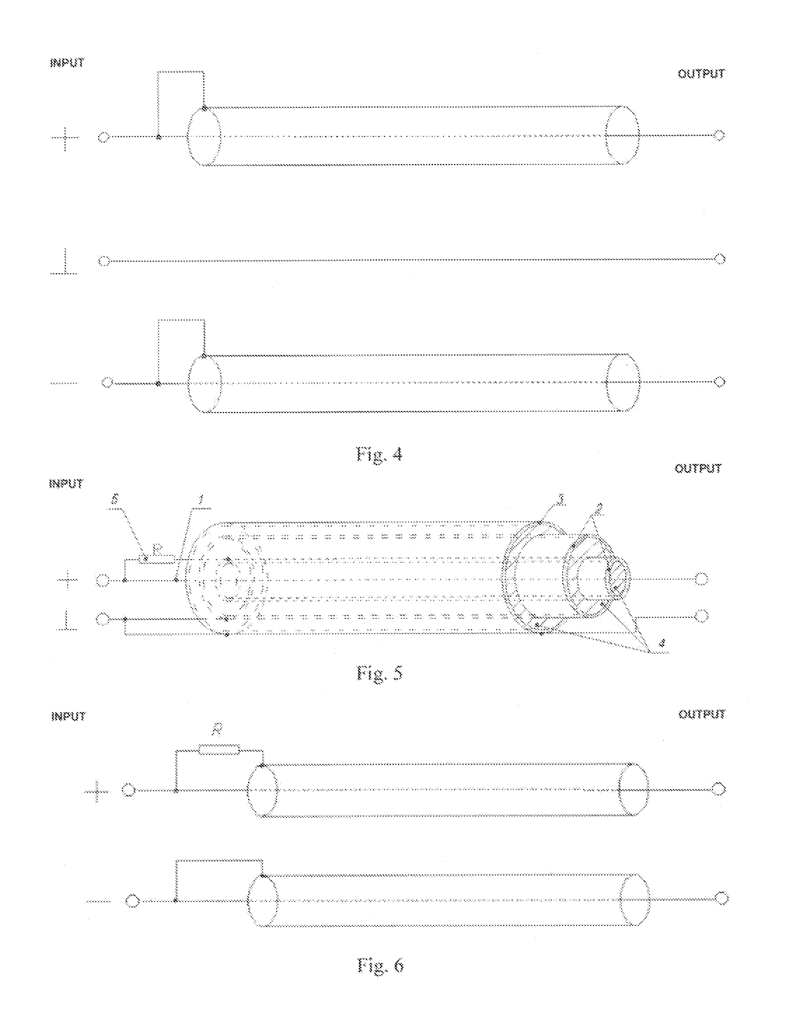

FIG. 4 shows the first alternative embodiment of the balanced cable with two screened signal wires;

FIG. 5 shows the second alternative embodiment of the coaxial cable with the screened signal wire and the screened external neutral wire using the resistor to connect the signal wire screen;

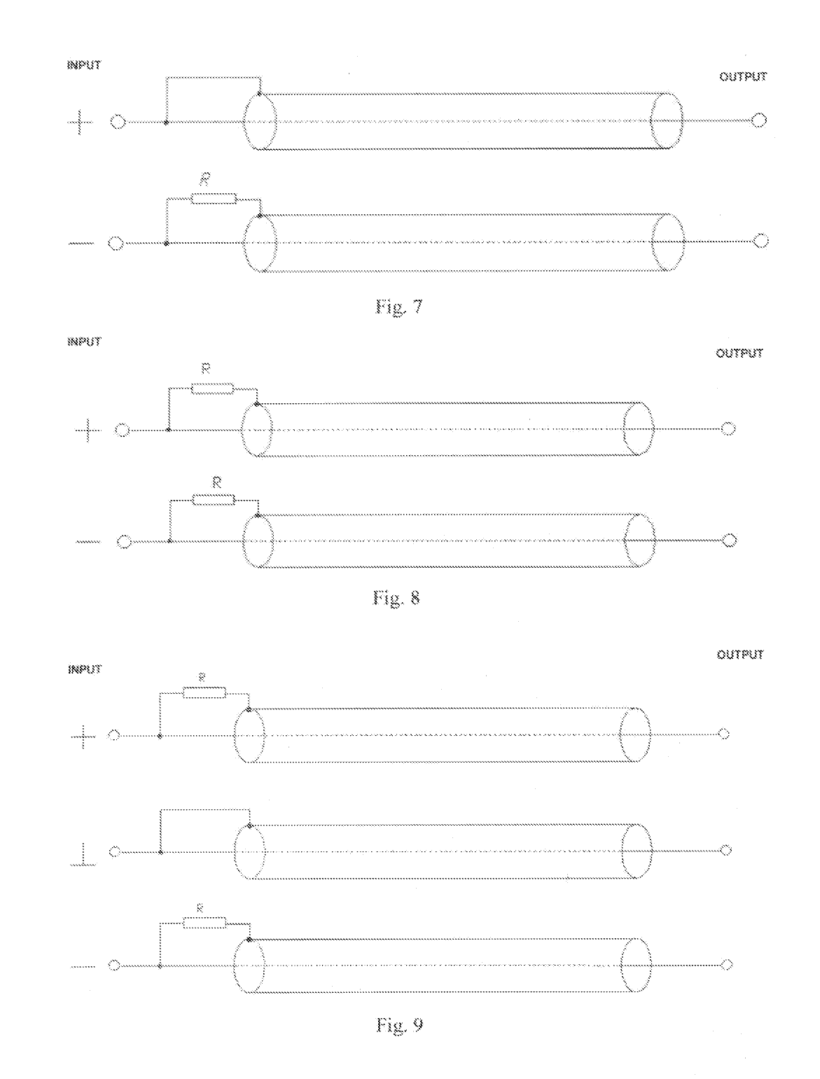

FIGS. 6, 7, 8 show the second alternative embodiments of the two-wire cables using resistors to connect the screens;

FIG. 9 shows the second alternative embodiment of the balanced three-wire cable with all the wires screened, and using the resistors to connect the screens of the signal wires;

FIG. 10 shows the second alternative embodiment of the three-wire balanced cable with all the wires screened, and using the resistors to connect the screens of all the wires;

FIG. 11 shows the second alternative embodiment of the three-wire balanced cable with only two signal wires screened, and using the resistors to connect the screens of all the signal wires.

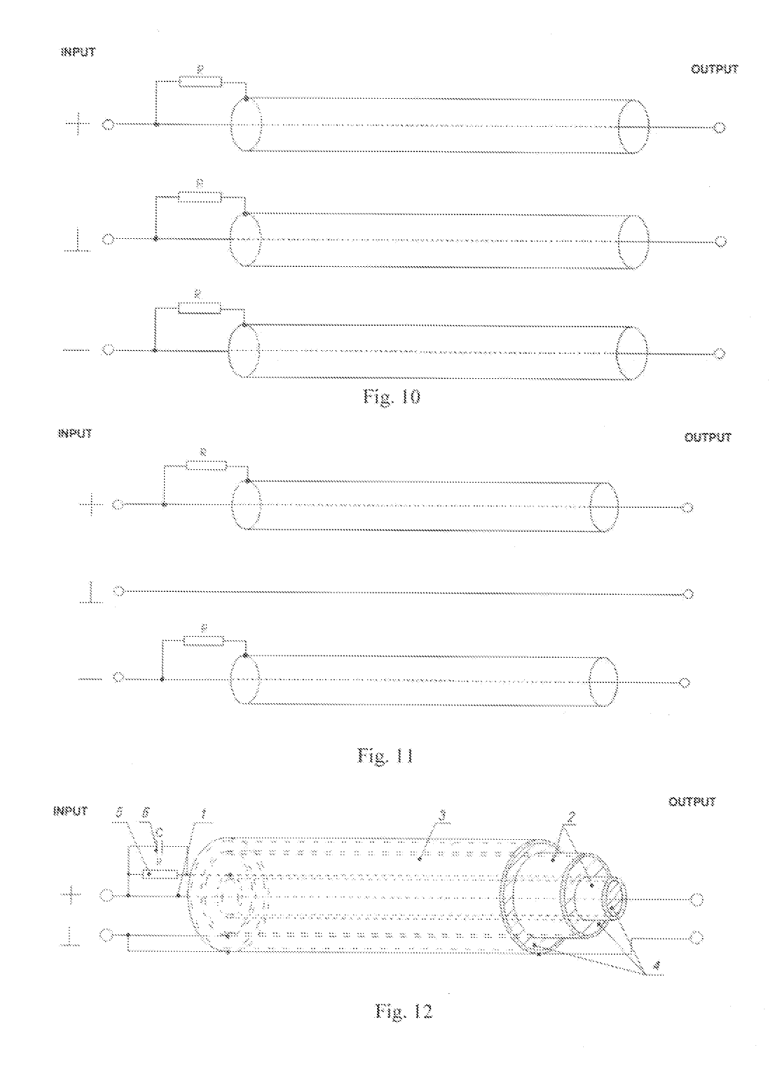

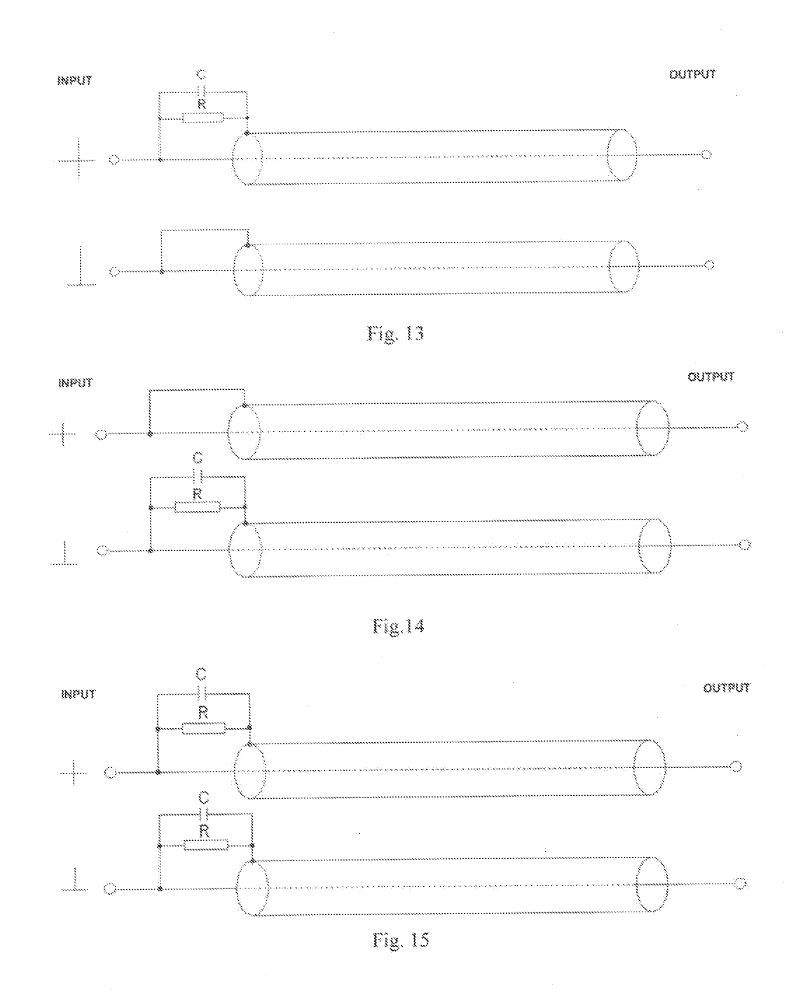

FIG. 12 shows the second alternative embodiment of the coaxial cable with the screened signal wire and the screened external neutral wire using the resistor and the capacitor to connect the signal wire screen;

FIGS. 13, 14, 15 show the second alternative embodiments of the two-wire cable using the resistor and the capacitor to connect the screens;

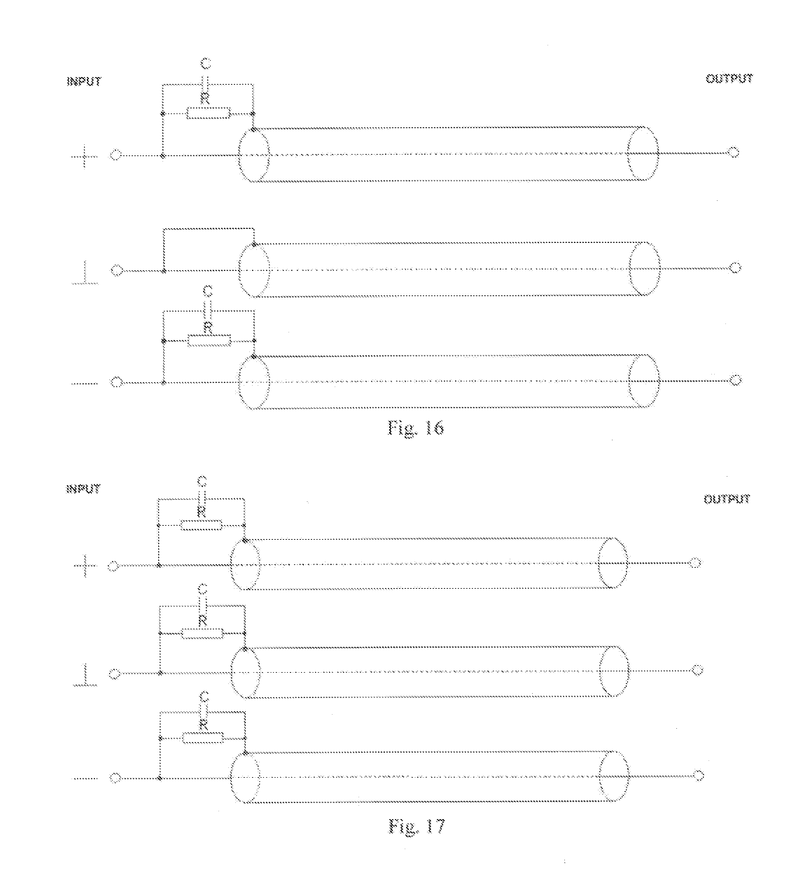

FIG. 16 shows the second alternative embodiment of the balanced three-wire cable with all the wires screened, and using the resistor and the capacitor to connect the screens of the signal wires;

FIG. 17 shows the second alternative embodiment of the balanced three-wire cable with all the wires screened, and using the resistor and the capacitor to connect the screens of all the wires;

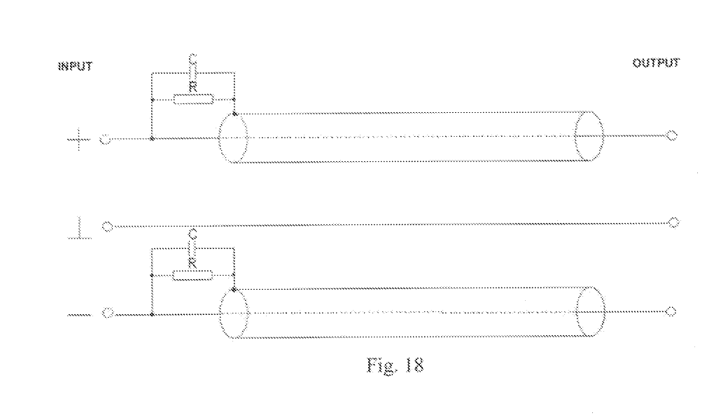

FIG. 18 shows the second alternative embodiment of the balanced three-wire cable with only two signal wires screened, and using the resistor and the capacitor to connect the screens of the signal wires.

The electric cable comprises one signal current-carrying wire 1, cylindrical screen 2, neutral current-carrying wire 3, dielectric 4, resistor 5, and capacitor 6.

Each wire screen 2, for example, of cylindrical configuration is energized by the voltage performed with the signal source being equal to the voltage at appropriate signal wire 1 or neutral wire 3, which is separated by above said screen 2.

Neutralizing of the distributed capacitance between neutral wire 3 and signal wire 1 eliminates the process of the capacitance charge exchange at changing the signal polarity that results in the elimination of the dielectric losses of the signal energy, which distort the shape of the signal passing through the cable, increase the velocity of the signal propagation, and reduce the group delay of the signal. Besides, at changing the direction of the dielectric polarization there is also excluded adding the noise generated by dielectric dipole molecules to the useful signal.

The availability of resistor 5 promotes suppressing of the parasitic electrical oscillating processes that might occur under the condition of the signal source output circuits' interaction with the capacitance in the space between screens 2 that also significantly improves the quality of the electrical signals transmission.

The availability of capacitor 6, which shunts resistor 5, creates the accelerating RC circuit and contributes to enhancing the bandwidth in the area of the upper frequencies.

1. The electric cable comprising at least two current-carrying wires; a signal wire and a neutral wire with dielectric layers between them, characterizing in that the current-carrying wires are separated from each other by at least three dielectric layers, and at least two screens of conductive material disposed between the dielectric layers alternating with them, and along the entire length of the cable, from its input to the output, each screen covers only one current-carrying wire connected to it on the input side.

2. The electric cable comprising at least two current-carrying wires; a signal wire and a neutral wire with dielectric layers between them, characterizing in that the current-carrying wires are separated from each other by at least three dielectric layers, and at least two screens of conductive material disposed between the dielectric layers alternating with them, each screen is connected to a current-carrying wire via a resistor, and along the entire length of the cable, from its input to the output, each screen covers only one current-carrying wire connected to it on the input side.

3. The electric cable comprising at least two current-carrying wires; a signal wire and a neutral wire with dielectric layers between them, characterizing in that the current-carrying wires are separated from each other by at least three dielectric layers, and at least two screens of conductive material disposed between the dielectric layers alternating with them, each screen is connected to a current-carrying wire via a resistor, which is shunted by a capacitor to expand the bandwidth of the cable, and along the entire length of the cable, from its input to the output, each screen covers only one current-carrying wire connected to it on the input side.
